(19) United States
(12) Patent Application Publication
(10) Pub. No.: US 2024/0386071 A1
(43) Pub. Date: Nov. 21, 2024

(54) AMPLITUDE PRESERVING METHOD AND SYSTEM BASED ON SYMMETRY OF GENERALIZED HAMILTON OPERATORS

(71) Applicant: Shanghai Institute of Technical Physics, CAS., Shanghai (CN)

(72) Inventors: Wenjun XU, Shanghai (CN); Shengli SUN, Shanghai (CN); Gaorui LIU, Shanghai (CN)

(73) Assignee: Shanghai Institute of Technical Physics, CAS., Shanghai (CN)

(21) Appl. No.: 18/665,953

(22) Filed: May 16, 2024

(30) Foreign Application Priority Data
May 17, 2023 (CN) 202310560790.8

(51) Int. Cl. G06F 17/14

(52) U.S. Cl. CPC G06F 17/14

(57) ABSTRACT

An amplitude preserving method and system based on symmetry of generalized Hamilton operators are provided. This method involves determining the dimensions of a decomposition equation based on up-going and down-going one-way wave equations. Additionally, an amplitude preserving form and boundary conditions are established for both up-going and down-going wave equations with varying dimensions. The traditional one-way wave processing procedure is then adjusted by a modified source function and initial boundary conditions until a one-way wave field recursive equation with an amplitude preserving condition is satisfied. Finally, a modified one-way wave program is used to obtain an amplitude preserving wave field, which is then compared to the results of a finite difference wave field or an analytical solution wave field for verification.

### CROSS-REFERENCE TO RELATED APPLICATION

This patent application claims the benefit and priority of Chinese Patent Application No. 202310560790.8 filed with the China National Intellectual Property Administration on May 17, 2023, the disclosure of which is incorporated by reference herein in its entirety as part of the present application.

### TECHNICAL FIELD

The present disclosure relates to the technical field of a generalized Hamilton dynamic system, in particular to an amplitude preserving method and system based on symmetry of generalized Hamilton operators.

### BACKGROUND

In recent years, the inverse problem research based on wave theories has been a hot and difficult issue in many physical fields, including imaging and inversion fields based on wave mechanics such as exploration seismology, mid-far infrared electromagnetic waves and microwaves. Wave propagation equations in different media can be reformulated in the form of generalized Hamilton canonical equations. According to Noether's theorem, Hamilton operator's symmetry implies conservation laws.

Conventional Full Waveform Inversion (FWI) methods often encounter difficulties in practice, for that “The theory is complete, but the application is challengeable: for example, an initial model seriously deviating from a real model, the lack of low frequency of real data, and incomplete observation lead to iteration non-convergence”. Consider of the deficiency of FWI, one-way methods are good options to approximate the two-way equations in implementation. At present, the main stream methods of one-way propagation equations include directional wave field decomposition methods, which decompose the full-wave equation of sound waves into two coupled up-going and down-going one-way wave equations. In homogeneous media, the up-going and down-going wave fields are decoupled. At this time, these methods can accurately characterize the kinematics and dynamics of wave motions. When the velocity gradient of the medium is not large, the traditional one-way wave approximation is applied to obtain high-precision results. The iterative solution of such methods can simulate the transmission and reflection of waves at the same time. However, due to the high computational cost, the problem of preserving the amplitude of the one-way wave equation is not specifically addressed. One method for improving the accuracy of travel time calculations is to use an amplitude correction approach based on a transport equation. This method demonstrates that while the traditional one-way function equation and the two-way function equation yield the same travel time accuracy, they produce different results when applied to the transport equation. By correcting for this error, the amplitude information of the one-way wave equation can be improved. Another approach is to correct for the violation of the reciprocity conservation principle. Wapenaar proposed a normalized energy flow decomposition method for layered media, which can correct the traditional one-way wave equation to adhere to the reciprocity principle and achieve the same level of amplitude calculation accuracy as the Wentzel-Kramers-Brillouin-Jeffreys (WKBJ) solution. The limitation of this method is that it can only be applied to local layered media. A fourth method is the multi-order one-way wave modeling method. In 2005, Kiyashchenko et al. proposed an iterative approach for calculating coupled up-going and down-going waves using perturbation theory. This method decomposes the full-wave equation into three equations: up-going waves, down-going waves, and error terms. In the initial iteration, independent up-going and down-going waves are calculated. In the first iteration, the error term is calculated using the wave field from the previous iteration. This error term is then used as a source function in the up-going and down-going wave equations. This process is repeated until the desired level of accuracy is achieved. However, this method is five times more computationally expensive than the traditional method. Similar to the first method, this approach does not address how to ensure the accurate output of one-way waves.

### SUMMARY

The purpose of this section is to summarize some aspects of the embodiments of the present disclosure and briefly introduce some preferred embodiments. Some simplification or omission may be made in this section, the abstract of the specification and the title of the present disclosure to avoid obscuring the purpose of this section, the abstract of the specification and the title of the present disclosure. Such simplification or omission cannot be used to limit the scope of the present disclosure.

In view of the problem that a one-way wave operator of an acoustic medium wave equation does not preserve the amplitude in the prior art, the present disclosure is proposed.

Therefore, the purpose of the present disclosure is to provide an amplitude preserving method based on symmetry of generalized Hamilton operators, so that through the symmetry of up-going and down-going wave propagators of a one-way wave, the amplitude preserving characteristics of the propagators are realized, and a reciprocity principle is satisfied under a conservative Hamilton dynamic system.

In order to solve the above technical problems, the present disclosure provides the following technical scheme.

In a first aspect, the present disclosure provides an amplitude preserving method based on symmetry of generalized Hamilton operators, including: determining dimensions of a decomposition equation according to different one-way wave equations; establishing an amplitude preserving form and boundary value condition of up-going and down-going wave equations with different dimensions; on the basis of a traditional one-way wave processing flow, performing adjustment according to a modified source function and an initial boundary value condition until a one-way wave field recursive equation with an amplitude preserving condition is satisfied; and operating a modified one-way wave equation to obtain an amplitude preserving wave field and verify a result with a finite difference wave field or an analytical solution wave field.

In an embodiment, the dimensions include dimensions of physical quantities in a constant-density sound pressure equation, and the constant-density sound pressure equation is expressed as:

$$[ \frac{1}{{υ}^{2} ( x )} \frac{{\partial }^{2}}{\partial {t}^{2}} - {∇}^{2} ] p ( x , t ) = - f ( x , t ; {x}_{s} ) \qquad ( 1 )$$

where the dimensions of respective physical quantities in equation (1) are as follows: a sound pressure is [p]=N/m², a sound wave propagation velocity is [v]=m/s, a Laplace operator is [∇²]=1/m², a time second-order partial derivative is

$$[ \frac{{\partial }^{2}}{\partial {t}^{2}} ] = 1 / {s}^{2} ,$$

a dimension of a three-dimensional space coordinate is [x=(x, y, z)]=m, a dimension of a time coordinate is [t]=s, [xₛ]=m is a position of a source function, and a dimension of the source function is the source function [f]=N/m⁴.

In an embodiment, the decomposition includes two strategies;
the strategy 1 includes decomposing a two-way sound wave equation (1) into a coupled one-way wave equation, which comprises:
assuming that

$$D = \frac{1}{2} ( \frac{\partial }{\partial z} + Λ ) p ( x , t ) and U = \frac{1}{2} ( \frac{\partial }{\partial z} - Λ ) p ( x , t ) ,$$

the equation (1) being decomposed into:

$$\{ \begin{matrix}( \frac{\partial }{\partial z} - Λ ) D - \frac{{Λ}_{z}}{2 Λ} ( D - U ) = - \frac{1}{2} f \\ ( \frac{\partial }{\partial z} + Λ ) U - \frac{{Λ}_{z}}{2 Λ} ( U - D ) = - \frac{1}{2} f\end{matrix} \qquad ( 2 )$$

where D and U are down-going and up-going wave fields, respectively, and the dimension of the both is N/m³;
a symbol of a pseudo-differential operator

$$Λ = \sqrt{\frac{1}{{υ}^{2} ( x )} \frac{{\partial }^{2}}{\partial {t}^{2}} - \frac{{\partial }^{2}}{\partial {x}^{2}} - \frac{{\partial }^{2}}{\partial {y}^{2}}}$$

has a dimension of 1/m, and a frequency wave number domain thereof is expressed as

$$Λ = {ik}_{z} = i \sqrt{\frac{{ω}^{2}}{{υ}^{2}} - {k}_{x}^{2} - {k}_{y}^{2}} ;$$

a symbol of a pseudo-differential operator

$${Λ}_{z} = \frac{\partial Λ}{\partial z}$$

has a dimension of 1/m².

In an embodiment, the strategy 2 includes decomposing the two-way sound wave equation (1) into the coupled one-way wave equation, which comprises:
assuming that D*=D/\sqrt{Λ} and U*=U/\sqrt{Λ}, the equation (1) being decomposed into:

$$\{ \begin{matrix}( \frac{\partial }{\partial z} - Λ ) {D}^{*} - \frac{{Λ}_{z}}{2 Λ} {U}^{*} = - \frac{1}{2 \sqrt{Λ}} f \\ ( \frac{\partial }{\partial z} + Λ ) {U}^{*} - \frac{{Λ}_{z}}{2 Λ} {D}^{*} = - \frac{1}{2 \sqrt{Λ}} f\end{matrix} \qquad ( 3 )$$

where D* and U* are decomposed wave fields of down-going and up-going waves different from the dimensions of D and U, respectively, and the dimension of the both is

$$N / {m}^{\frac{5}{2}} .$$

In an embodiment, the establishing an amplitude preserving form and boundary value condition includes establishing a true amplitude equation and boundary condition of a down-going wave through equations (2) and (3), which is expressed as follows:
the true amplitude equation and boundary condition of the down-going wave established by equation (2) is:

$$\{ \begin{matrix}( \frac{\partial }{\partial z} - Λ - \frac{{Λ}_{z}}{2 Λ} ) D ( x , t ) = 0 \\ D ( x , t ; z = {z}_{s} ) = - \frac{1}{2 Λ} f ( x , t ; z = {z}_{s} )\end{matrix} \qquad ( 4 )$$

the true amplitude equation and boundary condition of the down-going wave established by equation (3) is:

$$\{ \begin{matrix}( \frac{\partial }{\partial z} - Λ ) {D}^{*} ( x , t ) = 0 \\ {D}^{*} ( x , t ; z = {z}_{s} ) = - \frac{{Λ}^{- \frac{3}{2}}}{2} f ( x , t ; z = {z}_{s} )\end{matrix} . \qquad ( 5 )$$

In an embodiment, the traditional one-way wave processing flow includes selecting a Generalized Screen Propagator (GSP) as a one-way wave amplitude preserving-implemented method, and determining an approximate solution of a one-way wave operator L as follows:
according to equation (5), the approximate solution Λ₀^{W} of the generalized screen propagator of the one-way wave operator L in the frequency wave number domain is:

$${Λ}_{0}^{W} ( {x}_{T} , z ) = \sqrt{\frac{{ω}^{2}}{{υ}_{0}^{2}} + \frac{{\partial }^{2}}{\partial {x}_{T}^{2}}} + \frac{ω}{{υ}_{0}} ( \frac{1}{m} - 1 ) + \frac{ω}{{υ}_{0}} \frac{{a}_{1} ( m - 1 ) \frac{{υ}_{o}^{2}}{{ω}^{2}} \frac{{\partial }^{2}}{\partial {x}_{T}^{2}}}{1 + {b}_{1} ( 1 + {m}^{2} ) \frac{{υ}_{o}^{2}}{{ω}^{2}} \frac{{\partial }^{2}}{\partial {x}_{T}^{2}}} \qquad ( 6 )$$

where x_{T}=(x, y) denotes a plane coordinate, ω is an angular momentum, and v₀ is a reference velocity at the depth z;

$$m = m ( x ) = \frac{υ ( x )}{{υ}_{0} ( z )}$$

is a lateral velocity change; when

$$\frac{1}{{k}^{2} ( {x}_{T} , z )} \frac{{\partial }^{2}}{\partial {x}_{T}^{2}} = 0 ,$$

assuming that first to third derivatives of Λ and Λ₀^{W} are equal to each other, optimal optimization parameters are solved to obtain a₁=0.5 and b₁=0.25; three terms in equation (6) include a phase shift term, a phase correction term and a wide-angle finite difference correction term, and the operators corresponding to these three terms are referred to as a one-way wave generalized screen propagator, a phase correction operator and a wide-angle amplitude correction operator.

In an embodiment, the recursive equation includes a recursive equation of a down-going wave field p of a one-way wave with a sound pressure dimension obtained according to down-going wave fields with different dimensions;
according to the down-going wave field D with the dimension of N/m³ in equation (4), the recursive equation of the down-going wave field p of the one-way wave with the sound pressure dimension obtained after the dimension is normalized is as follows:

$$\{ \begin{matrix}p ( x , z , t ) = \frac{D ( x , z , t )}{Λ} , z = {z}_{s} \\ \frac{p ( x , z + Δ z , t )}{p ( x , z , t )} = \frac{Λ ( x , z , t ) D ( x , z + Δ z , t )}{Λ ( x , z + Δ z , t ) D ( x , z , t )} z > {z}_{s}\end{matrix} \qquad ( 7 )$$

where Δz is a depth step, and zₛ is a depth of the source function;
according to the down-going wave field D* with the dimension of

$$N / {m}^{\frac{5}{2}}$$

in equation (5), the recursive equation of the down-going wave field p of the one-way wave with the sound pressure dimension obtained after the dimension is normalized is as follows:

$$\{ \begin{matrix}p ( x , z , t ) = \frac{{D}^{*} ( x , z , t )}{\sqrt{Λ}} , z = {z}_{s} \\ \frac{p ( x , z + Δ z , t )}{p ( x , z , t )} = \frac{\sqrt{Λ ( x , z , t )} {D}^{*} ( x , z + Δ z , t )}{\sqrt{Λ ( x , z + Δ z , t )} {D}^{*} ( x , z , t )} , z > {z}_{2}\end{matrix} \qquad ( 8 )$$

where Δz is a depth step, and zₛ is a depth of the source function.

In a second aspect, an embodiment of the present disclosure provides an amplitude preserving system based on symmetry of generalized Hamilton operators, wherein steps of the method described above are implemented by any computer programming language, and a program is compiled and operated on any operating system and any hardware structure.

In a third aspect, an embodiment of the present disclosure provides a computer device, including a memory in which a computer program is stored and a processor, wherein the processor, when executing the computer program, implements the steps of the method described above.

In a fourth aspect, an embodiment of the present disclosure provides a non-transitory computer-readable storage medium on which a computer program is stored, wherein the computer program, when executed by a processor, implements the steps of the method described above.

The present disclosure has the following beneficial effects. Based on the acoustic medium wave equation under the generalized Hamilton dynamic system, through the symmetry of up-going and down-going wave propagators of a one-way wave, the amplitude preserving characteristics of the propagators are realized, and a reciprocity principle is satisfied under a conservative Hamilton dynamic system.

### BRIEF DESCRIPTION OF THE DRAWINGS

In order to explain the technical scheme of the embodiment of the present disclosure more clearly, the drawings used in the description of the embodiment will be briefly introduced hereinafter. Obviously, the drawings in the following description are only some embodiments of the present disclosure. For those skilled in the art, other drawings can be obtained according to these drawings without creative efforts.

FIG. 1 is a flowchart of an amplitude preserving method based on symmetry of generalized Hamilton operators according to the present disclosure.

FIG. 2A is a schematic diagram of a wave field value generated by the acoustic medium one-way wave operator without being processed by the amplitude preserving method.

FIG. 2B is a schematic diagram of an amplitude preserving propagation wave field value of a sound wave calculated by operator symmetry.

### DETAILED DESCRIPTION OF THE EMBODIMENTS

In order to make the above objects, features and advantages of the present disclosure more obvious and understandable, the detailed description of the present disclosure will be described in detail with reference to the attached drawings hereinafter.

In the following description, many specific details are set forth in order to fully understand the present disclosure, but the present disclosure can also be implemented in other ways different from those described here. Those skilled in the art can make similar promotion without violating the connotation of the present disclosure. Therefore, the present disclosure is not limited by the specific embodiments provided hereinafter.

Second, “one embodiment” or “an embodiment” referred to here indicates a specific feature, structure or characteristic that can be included in at least one implementation of the present disclosure. The appearances of “in one embodiment” in different places in this specification do not all refer to the same embodiment, nor are they separate or selective embodiments mutually exclusive of other embodiments.

Thereafter, the present disclosure will be described in detail with reference to the schematic diagram. When describing the embodiment of the present disclosure in detail, for the convenience of explanation, the cross-sectional diagram showing the device structure will not be partially enlarged to scale, and the schematic diagram is only an example, which should not limit the scope of protection of the present disclosure here. In addition, the three-dimensional dimensions of length, width and depth should be included in the actual production.

### Embodiment 1

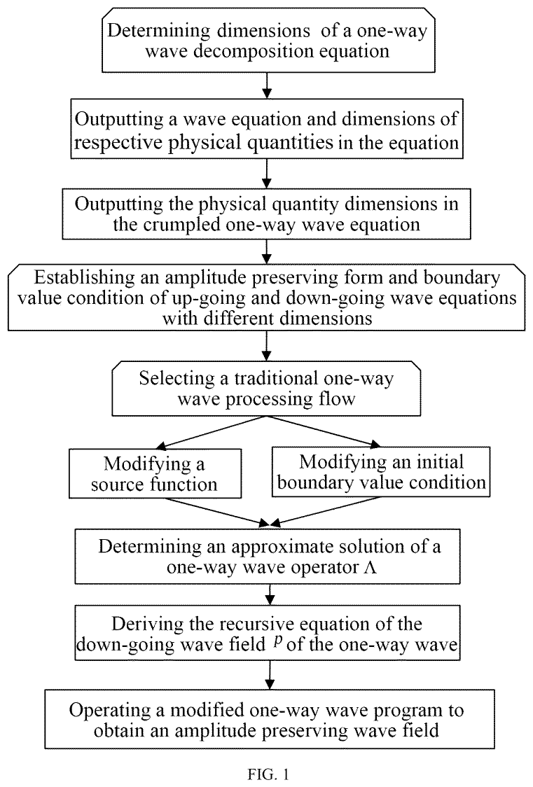

Referring to FIG. 1, which is a first embodiment of the present disclosure, an amplitude preserving method based on symmetry of generalized Hamilton operators is provided, which includes steps S1-S4.

In step S1, dimensions of a decomposition equation are determined according to different one-way wave equations.

The dimensions include dimensions of physical quantities in a constant-density sound pressure equation, and the constant-density sound pressure equation is expressed as:

$$[ \frac{1}{{υ}^{2} ( x )} \frac{{\partial }^{2}}{\partial {t}^{2}} - {∇}^{2} ] p ( x , t ) = - f ( x , t ; {x}_{s} ) \qquad ( 1 )$$

where the dimensions of the respective physical quantities in equation (1) are as follows: a sound pressure is [p]=N/m², a sound wave propagation velocity is [v]=m/s, a Laplace operator is [∇²]=1/m², a time second-order partial derivative is

$$[ \frac{{\partial }^{2}}{\partial {t}^{2}} ] = 1 / {s}^{2} ,$$

a dimension of a three-dimensional space coordinate is [x=(x, y, z)]=m, a dimension of a time coordinate is [t]=s, [xₛ]=m is a position of a source function, and the dimension of the source function is the source function [f]=N/m⁴.

The decomposition includes the following two strategies.

The strategy 1 includes decomposing a two-way sound wave equation (1) into a coupled one-way wave equation, specifically:
assuming that

$$D = \frac{1}{2} ( \frac{\partial }{\partial z} + Λ ) p ( x , t ) and U = \frac{1}{2} ( \frac{\partial }{\partial z} - Λ ) p ( x , t ) ,$$

the equation (1) is decomposed into:

$$\{ \begin{matrix}( \frac{\partial }{\partial z} - Λ ) D - \frac{{Λ}_{z}}{2 Λ} ( D - U ) = - \frac{1}{2} f \\ ( \frac{\partial }{\partial z} + Λ ) D - \frac{{Λ}_{z}}{2 Λ} ( U - D ) = - \frac{1}{2} f\end{matrix} \qquad ( 2 )$$

where D and U are down-going and up-going wave fields, respectively, and the dimension is N/m³;
a symbol of a pseudo-differential operator

$$Λ = \sqrt{\frac{1}{{υ}^{2} ( x )} \frac{{\partial }^{2}}{\partial {t}^{2}} - \frac{{\partial }^{2}}{\partial {x}^{2}} - \frac{{\partial }^{2}}{\partial {y}^{2}}}$$

has a dimension of 1/m, and a frequency wave number domain thereof is expressed as

$$Λ = {ik}_{z} = i \sqrt{\frac{{ω}^{2}}{{υ}^{2}} - {k}_{x}^{2} - {k}_{y}^{2}} ;$$

a symbol of a pseudo-differential operator

$${Λ}_{z} = \frac{\partial Λ}{\partial z}$$

has a dimension of 1/m².

The strategy 2 includes decomposing the two-way sound wave equation (1) into the coupled one-way wave equation, specifically:
assuming that D*=D/\sqrt{Λ} and U*=U/\sqrt{Λ}, the equation (1) is decomposed into:

$$\{ \begin{matrix}( \frac{\partial }{\partial z} - Λ ) {D}^{*} - \frac{{Λ}_{z}}{2 Λ} {U}^{*} = - \frac{1}{2 \sqrt{Λ}} f \\ ( \frac{\partial }{\partial z} + Λ ) {U}^{*} + \frac{{Λ}_{z}}{2 Λ} {D}^{*} = - \frac{1}{2 \sqrt{Λ}} f\end{matrix} \qquad ( 3 )$$

where D* and U* are decomposed wave fields of down-going and up-going waves different from the dimensions of D and U, respectively, and the dimension is

$$N / {m}^{\frac{5}{2}} .$$

In step S2, an amplitude preserving form and boundary value condition of up-going and down-going wave equations with different dimensions is established.

The establishing an amplitude preserving form and boundary value condition includes establishing a true amplitude equation and boundary condition of a down-going wave through equations (2) and (3), which is expressed as follows:
the true amplitude equation and boundary condition of the down-going wave established by equation (2) is:

$$\{ \begin{matrix}( \frac{\partial }{\partial z} - Λ - \frac{{Λ}_{z}}{2 Λ} ) D ( x , t ) = 0 \\ D ( x , t ; z = {z}_{s} ) = - \frac{1}{2 Λ} f ( x , t ; z = {z}_{s} )\end{matrix} \qquad ( 4 )$$

the true amplitude equation and boundary condition of the down-going wave established by equation (3) is:

$$\{ \begin{matrix}( \frac{\partial }{\partial z} - Λ ) {D}^{*} ( x , t ) = 0 \\ {D}^{*} ( x , t ; z = {z}_{s} ) = - \frac{{Λ}^{- \frac{3}{2}}}{2} f ( x , t ; z = {z}_{s} )\end{matrix} . \qquad ( 5 )$$

In step S3, on the basis of a traditional one-way wave processing flow, adjustment is performed according to a modified source function and an initial boundary value condition until a one-way wave field recursive equation with an amplitude preserving condition is satisfied.

The traditional one-way wave processing flow includes selecting a Generalized Screen Propagator (GSP) for implementing the one-way wave amplitude preserving-implemented method, and determining an approximate solution of a one-way wave operator L as follows:
according to equation (5), an approximate solution Λ₀^{W} of a generalized screen propagator of the one-way wave operator L in a frequency wave number domain is:

$${Λ}_{0}^{W} ( {x}_{T} , z ) = \sqrt{\frac{{ω}^{2}}{{v}_{0}^{2}} + \frac{{\partial }^{2}}{\partial {x}_{T}^{2}}} + \frac{ω}{{v}_{0}} ( \frac{1}{m} - 1 ) + \frac{ω}{{v}_{0}} \frac{{a}_{1} ( m - 1 ) \frac{{v}_{o}^{2}}{{ω}^{2}} \frac{{\partial }^{2}}{\partial {x}_{T}^{2}}}{1 + {b}_{1} ( 1 + {m}^{2} ) \frac{{v}_{o}^{2}}{{ω}^{2}} \frac{{\partial }^{2}}{\partial {x}_{T}^{2}}} \qquad ( 6 )$$

where a plane coordinate is x_{T}=(x, y), ω is an angular momentum, and v₀ is a reference velocity at the depth z;

$$m = m ( x ) = \frac{v ( x )}{{v}_{0} ( z )}$$

is a lateral velocity change; when

$$\frac{1}{{k}^{2} ( {x}_{T} , z )} \frac{{\partial }^{2}}{\partial {x}_{T}^{2}} = 0 ,$$

assuming that the first to third derivatives of Λ and Λ₀^{W} are equal to each other, optimal optimization parameters are solved as a₁=0.5 and b₁=0.25; three terms in equation (6) include a phase shift term, a phase correction term and a wide-angle finite difference correction term, and the operators corresponding to these three terms are referred to as a one-way wave generalized screen propagator, a phase correction operator and a wide-angle amplitude correction operator.

The recursive equation includes a recursive equation of a down-going wave field p of a one-way wave with a sound pressure dimension obtained according to down-going wave fields with different dimensions.

According to the down-going wave field D with the dimension of N/m³ in equation (4), the recursive equation of the down-going wave field p of the one-way wave with the sound pressure dimension obtained after the dimension is normalized is as follows:

$$\{ \begin{matrix}p ( x , z , t ) = \frac{D ( x , z , t )}{Λ} , z = {z}_{s} \\ \begin{matrix}\frac{p ( x , z + Δ z , t )}{p ( x , z , t )} = \frac{Λ ( x , z , t ) D ( x , z + Δ z , t )}{Λ ( x , z + Δ z , t ) D ( x , z , t )} & z > {z}_{s}\end{matrix}\end{matrix} \qquad ( 7 )$$

where Δz is a depth step, and zₛ is a depth of the source function.

According to the down-going wave field D* with the dimension of

$$N / {m}^{\frac{5}{2}}$$

in equation (5), the recursive equation of the down-going wave field p of the one-way wave with the sound pressure dimension obtained after the dimension is normalized is as follows:

$$\{ \begin{matrix}p ( x , z , t ) = \frac{{D}^{*} ( x , z , t )}{\sqrt{Λ}} , z = {z}_{s} \\ \frac{p ( x , z + Δ z , t )}{p ( x , z , t )} = \frac{\sqrt{Λ ( x , z , t )} {D}^{*} ( x , z + Δ z , t )}{\sqrt{Λ ( x , z + Δ z , t )} {D}^{*} ( x , z , t )} , z > {z}_{s}\end{matrix} \qquad ( 8 )$$

where Δz is a depth step, and zₛ is a depth of the source function.

In step S4, a modified one-way wave program is operated to obtain an amplitude preserving wave field and verify a result with a finite difference wave field or an analytical solution wave field.

Further, this embodiment further provides an amplitude preserving system based on symmetry of generalized Hamilton operators, wherein steps of the method described above are implemented by any computer programming language, and a program is compiled and operated on any operating system and any hardware structure.

This embodiment further provides a computer device, which is suitable for the case of the amplitude preserving method based on symmetry of generalized Hamilton operators and includes a memory and a processor, wherein a computer-executable instruction is stored in the memory, wherein when the processor, which executing the computer-executable instruction, implements a method of identifying a household-changing relationship of a power substation as proposed in the above embodiment.

The computer device can be a terminal. The computer device includes a processor, a memory, a communication interface, a display screen and an input device connected through a system bus. The processor of the computer device is used to provide computing and control capabilities. The memory of the computer device includes a nonvolatile storage medium and an internal memory. The nonvolatile storage medium stores an operating system and a computer program. The internal memory provides an environment for the operation of the operating system and the computer program in the nonvolatile storage medium. The communication interface of the computer device is in wired or wireless communication with external terminals. The wireless mode can be implemented by WIFI, an operator network, NFC (Near Field Communication) or other technologies. The display screen of the computer device can be a liquid crystal display screen or an electronic ink display screen. The input device of the computer device can be a touch layer covered on the display screen, or a button, a trackball or a touchpad provided on the shell of the computer device, or an external keyboard, a touchpad or a mouse.

This embodiment further provides a storage medium on which a computer program is stored, wherein the program, when executed by a processor, implements the amplitude preserving method based on symmetry of generalized Hamilton operators as proposed in the above embodiment.

The storage medium proposed in this embodiment belongs to the same inventive concept as the data storage method proposed in the above embodiment. For technical details not described in detail in this embodiment, refer to the above embodiment. Moreover, this embodiment has the same beneficial effects as the above embodiment.

To sum up, based on the acoustic medium wave equation under the generalized Hamilton dynamic system, through the symmetry of up-going and down-going wave propagators of a one-way wave, the amplitude preserving characteristics of the propagators are realized, and a reciprocity principle is satisfied under a conservative Hamilton dynamic system.

### Embodiment 2

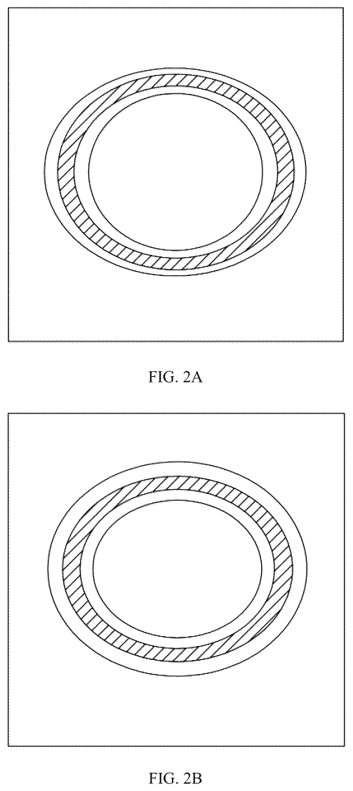

Referring to FIGS. 1 and 2A-2B, which is a second embodiment of the present disclosure, this embodiment is different from the first embodiment in that a specific application of the method of the present disclosure is provided.

A first order differential equation system of a generalized Hamilton canonical equation is in the form of:

$$H ( p , q ) = T ( p ) + V ( q ) = \frac{1}{2} ( p , {M}^{- 1} p ) + V ( p ) \\ \dot{p} = - \frac{\partial H}{\partial q} \\ \dot{q} = \frac{\partial H}{\partial p}$$

where p=M\dot{q} is a momentum,

$$\dot{p} = \frac{dp}{dt} = ( {\dot{p}}_{1} , … , {\dot{p}}_{n} )$$

is an acting force, M is a mass, q=(q₁, . . . , qₙ) is a position vector,

$$\dot{q} = \frac{dq}{dt} = ( {\dot{q}}_{1} , … , {\dot{q}}_{n} )$$

is a velocity vector,

$$\ddot{q} = \frac{dq}{dt} = ( {\ddot{q}}_{1} , … , {\ddot{q}}_{n} )$$

is an acceleration vector; T is a kinetic energy function, V is a potential energy function; and H=T+V is a Hamilton quantity, which denotes a total energy.

According to the decomposition forms of up-going and down-going waves of the one-way wave equation with different dimensions, the amplitude preserving form of the one-way wave equation with different dimensions and its initial boundary value condition are proposed. Further, under the existing framework implemented by the one-way wave, the amplitude preserving processing of the one-way wave is implemented by the modified source function and the initial boundary value condition. The specific technical method includes the following steps.

In step S1, dimensions of different one-way wave decomposition equations are determined, that is, the one-way wave equation discussed is a physical quantity with a certain dimension.

A constant-density sound pressure equation and dimensions of respective physical quantities in the equation are output as follows:

The constant-density sound pressure equation is expressed as:

$$[ \frac{1}{{v}^{2} ( x )} \frac{{\partial }^{2}}{\partial {t}^{2}} - {∇}^{2} ] p ( x , t ) = - f ( x , t ; {x}_{s} ) \qquad ( 1 )$$

where the dimensions of the respective physical quantities in equation (1) are as follows: a sound pressure is [p]=N/m², a sound wave propagation velocity is [v]=m/s, a Laplace operator is [∇²]=1/m², a time second-order partial derivative is

$$[ \frac{{\partial }^{2}}{\partial {t}^{2}} ] = 1 / {s}^{2} , a$$

dimension of a three-dimensional space coordinate is [x=(x, y, z)]=m, a dimension of a time coordinate is [t]=s, [xₛ]=m is a position of a source function, and the dimension of the source function is the source function [f]=N/m⁴.

A coupled one-way wave equation expressed in different dimensions and dimensions of the respective physical quantities in the equation are output.

According to the different expected observations of the problem researchers, the constant-density sound wave equation can be decomposed into a coupled one-way wave form expressed in different dimensions.

The present disclosure only gives two examples of exemplary decomposition strategies, as shown in the following steps.

The strategy 1 includes decomposing a two-way sound wave equation (1) into a coupled one-way wave equation:
assuming that

$$\\ D = \frac{1}{2} ( \frac{\partial }{\partial z} + Λ ) p ( x , t ) and U = \frac{1}{2} ( \frac{\partial }{\partial z} - Λ ) p ( x , t ) ,$$

the equation (1) is decomposed into:

$$\\ \begin{matrix}\{ \begin{matrix}( \frac{\partial }{\partial z} - Λ ) D - \frac{{Λ}_{z}}{2 Λ} ( D - U ) = - \frac{1}{2} f \\ ( \frac{\partial }{\partial z} + Λ ) U - \frac{{Λ}_{z}}{2 Λ} ( U - D ) = - \frac{1}{2} f\end{matrix} & ( 2 )\end{matrix}$$

where D and U are down-going and up-going wave fields, respectively, and the dimension is N/m³;
a symbol of a pseudo-differential operator

$$\\ Λ = \sqrt{\frac{1}{{v}^{{}_{} 2} ( x )} \frac{{\partial }^{{}_{} 2}}{\partial {t}^{{}_{} 2}} - \frac{{\partial }^{{}_{} 2}}{\partial {x}^{{}_{} 2}} - \frac{{\partial }^{{}_{} 2}}{\partial {y}^{{}_{} 2}}}$$

has a dimension of 1/m, and a frequency wave number domain thereof is expressed as

$$\\ Λ = {ik}_{z} = i \sqrt{\frac{{ω}^{{}_{} 2}}{{v}^{{}_{} 2}} - {k}_{x}^{{}_{} 2} - {k}_{y}^{{}_{} 2}} ;$$

a symbol of a pseudo-differential operator

$$\\ {Λ}_{z} = \frac{\partial Λ}{\partial z}$$

has a dimension of 1/m².

The strategy 2 includes decomposing the two-way sound wave equation (1) into the coupled one-way wave equation:
assuming that D*=D/\sqrt{Λ} and U*=U/\sqrt{Λ}, the equation (1) is decomposed into:

$$\\ \begin{matrix}\{ \begin{matrix}( \frac{\partial }{\partial z} - Λ ) {D}^{{}_{} *} - \frac{{Λ}_{z}}{2 Λ} {U}^{{}_{} *} = - \frac{1}{2 \sqrt{Λ}} f \\ ( \frac{\partial }{\partial z} + Λ ) {U}^{{}_{} *} + \frac{{Λ}_{z}}{2 Λ} {D}^{{}_{} *} = - \frac{1}{2 \sqrt{Λ}} f\end{matrix} & ( 3 )\end{matrix}$$

where D* and U* are decomposed wave fields of down-going and up-going waves different from the dimensions of D and U, respectively, and the dimension is

$$\\ N / {m}^{{}_{} \frac{5}{2}} .$$

In step S2, an amplitude preserving form and initial boundary value condition of up-going and down-going wave equations with different dimensions is given.

According to different dimensions, the up-going and down-going wave fields can be expressed in more different forms. When the actual numerical values are realized, the up-going and down-going wave fields D* and U* of equations (2) and (3) need to satisfy the spatial reciprocity principle to achieve the purpose of preserving the amplitude. Therefore, the true amplitude equation and boundary condition of a down-going wave with different dimensions is established as follows.

The true amplitude equation and boundary condition of the down-going wave established by equation (2) is:

$$\\ \begin{matrix}\{ \begin{matrix}( \frac{\partial }{\partial z} - Λ - \frac{{Λ}_{z}}{2 Λ} ) D ( x , t ) = 0 \\ D ( x , t ; z = {z}_{s} ) = - \frac{1}{2 Λ} f ( x , t ; z = {z}_{s} )\end{matrix} & ( 4 )\end{matrix}$$

the true amplitude equation and boundary condition of the down-going wave established by equation (3) is:

$$\\ \begin{matrix}\{ \begin{matrix}( \frac{\partial }{\partial z} - Λ ) {D}^{{}_{} *} ( x , t ) = 0 \\ {D}^{{}_{} *} ( x , t ; z = {z}_{s} ) = - \frac{{Λ}^{- \frac{3}{2}}}{2} f ( x , t ; z = {z}_{s} )\end{matrix} & ( 5 )\end{matrix}$$

In step S3, a traditional one-way wave processing flow is selected, and on the basis of the flow, according to a modified source function and an initial boundary value condition, a one-way wave field recursive equation with an amplitude preserving condition is satisfied.

The traditional one-way wave equation processing flow is selected, and an approximate solution of a one-way wave operator L is determined.

The traditional solution methods of the one-way wave operator L include phase shift (PS), split-step Fourier (SSF), frequency-space finite difference (FSFD), Fourier finite difference (FFD), a generalized screen propagator (GSP), a local cosine basis (LCB) and so on, which can be applied in the method. Here, the GSP is taken as an exemplary case of the one-way wave amplitude preserving-implemented method. According to equation (5), an approximate solution Λ₀^{W} of a generalized screen propagator of the one-way wave operator L in a frequency wave number domain is:

$$\\ \begin{matrix}{Λ}_{{}_{} 0}^{{}_{} W} ( {x}_{T} , z ) = \sqrt{\frac{{ω}^{{}_{} 2}}{{v}_{0}^{{}_{} 2}} + \frac{{\partial }^{{}_{} 2}}{\partial {x}_{T}^{{}_{} 2}}} + \frac{ω}{{v}_{0}} ( \frac{1}{m} - 1 ) + \frac{ω}{{v}_{0}} \frac{{a}_{1} ( m - 1 ) \frac{{v}_{o}^{{}_{} 2}}{{ω}^{{}_{} 2}} \frac{{\partial }^{{}_{} 2}}{\partial {x}_{T}^{{}_{} 2}}}{1 + {b}_{1} ( 1 + {m}^{{}_{} 2} ) \frac{{v}_{o}^{{}_{} 2}}{{ω}^{{}_{} 2}} \frac{{\partial }^{{}_{} 2}}{\partial {x}_{T}^{{}_{} 2}}} & ( 6 )\end{matrix}$$

where a plane coordinate is x_{T}=(x, y), ω is an angular momentum, and v₀ is a reference velocity at the depth z;

$$\\ m = m ( x ) = \frac{v ( x )}{{v}_{0} ( z )}$$

is a lateral velocity change; when

$$\\ \frac{1}{{k}^{{}_{} 2} ( {x}_{T} , z )} \frac{{\partial }^{{}_{} 2}}{\partial {x}_{T}^{{}_{} 2}} = 0 ,$$

assuming that first to third derivatives of Λ and Λ₀^{W} are equal to each other, optimal optimization parameters are solved as a₁=0.5 and b₁=0.25; three terms in equation (6) include a phase shift term, a phase correction term and a wide-angle finite difference correction term and the operators corresponding to these three terms are referred to as a one-way wave generalized screen propagator, a phase correction operator and a wide-angle amplitude correction operator.

A recursive equation of a down-going wave field p of a one-way wave with a sound pressure dimension is obtained according to down-going wave fields with different dimensions.

According to the down-going wave field D with the dimension of N/m³ in equation (4), the recursive equation of the down-going wave field p of the one-way wave with the sound pressure dimension obtained after the dimension is normalized is as follows:

$$\\ \begin{matrix}\{ \begin{matrix}p ( x , z , t ) = \frac{D ( x , z , t )}{Λ} , z = {z}_{s} \\ \frac{p ( x , z + Δ z , t )}{p ( x , z , t )} = \frac{Λ ( x , z , t ) D ( x , z + Δ z , t )}{Λ ( x , z + Δ z , t ) D ( x , z , t )} z > {z}_{s}\end{matrix} & ( 7 )\end{matrix}$$

where Δz is a depth step, and zₛ is a depth of the source function.

According to the down-going wave field D* with the dimension of

$$\\ N / {m}^{{}_{} \frac{5}{2}}$$

in equation (5), the recursive equation of the down-going wave field p of the one-way wave with the sound pressure dimension obtained after the dimension is normalized is as follows:

$$\\ \begin{matrix}\{ \begin{matrix}p ( x , z , t ) = \frac{{D}^{{}_{} *} ( x , z , t )}{\sqrt{Λ}} , z = {z}_{s} \\ \frac{p ( x , z + Δ z , t )}{p ( x , z , t )} = \frac{\sqrt{Λ ( x , z , t )} {D}^{{}_{} *} ( x , z + Δ z , t )}{\sqrt{Λ ( x , z + Δ z , t )} {D}^{{}_{} *} ( x , z , t )} , z > {z}_{s}\end{matrix} & ( 8 )\end{matrix}$$

where Δz is a depth step, and zₛ is a depth of the source function.

In step S4, a modified one-way wave program is operated to obtain an amplitude preserving wave field and verify a result with a finite difference wave field or an analytical solution wave field.

FIG. 2A is a wave field value without amplitude preservation generated by the acoustic medium one-way wave operator without being processed by the amplitude preserving method; and FIG. 2B is an amplitude preserving propagation wave field value of a sound wave calculated by operator symmetry (the field value dimension is a sound pressure N/m²). After being processed by the amplitude preservation, the propagation amplitude compensation is realized when the propagation angle is nearly 90 degrees, so that the one-way wave propagation effect is consistent with the two-way wave propagation effect.

To sum up, the present disclosure mainly aims at improving the characteristics that the one-way wave operator of the acoustic medium wave equation under the generalized Hamilton dynamic system has no amplitude preservation. The symmetry of up-going and down-going wave propagators of a one-way wave is used, the amplitude preserving characteristics of the propagators are realized, and a reciprocity principle is satisfied under a conservative Hamilton dynamic system. Based on the traditional one-way wave technical process, it is necessary and has a wide theoretical significance and application value to ensure the amplitude characteristics of one-way wave propagation in the generalized Hamilton wave form through dimensional normalization without changing the original calculation framework.

It should be noted that the above embodiments are only used to illustrate the technical scheme of the present disclosure, rather than limit the technical scheme. Although the present disclosure has been described in detail with reference to the preferred embodiments, those skilled in the art should understand that the technical scheme of the present disclosure can be modified or replaced by equivalents without departing from the spirit and scope of the technical scheme, which should be included in the scope of the claims of the present disclosure.

What is claimed is:

1. An amplitude preserving method based on symmetry of generalized Hamilton operators, comprising:
determining dimensions of a decomposition equation according to different one-way wave equations;
establishing an amplitude preserving form and boundary value condition of up-going and down-going wave equations with different dimensions;
performing, on a basis of a traditional one-way wave processing flow, adjustment according to a modified source function and an initial boundary value condition until a one-way wave field recursive equation with an amplitude preserving condition is satisfied; and
operating a modified one-way wave equation to obtain an amplitude preserving wave field and verify a result with a finite difference wave field or an analytical solution wave field.

2. The amplitude preserving method according to claim 1, wherein the dimensions comprise dimensions of physical quantities in a constant-density sound pressure equation, and the constant-density sound pressure equation is expressed as:
$$[ \frac{1}{{υ}^{2} ( x )} \frac{{\partial }^{2}}{\partial {t}^{2}} - {∇}^{2} ] p ( x , t ) = - f ( x , t ; {x}_{s} ) \qquad ( 1 )$$
wherein the dimensions of the respective physical quantities in equation (1) are as follows: a sound pressure is [p]=N/m², a sound wave propagation velocity is [b]=m/s, a Laplace operator is [∇²]=1/m², a time second-order partial derivative is
$$[ \frac{{\partial }^{2}}{\partial {t}^{2}} ] = 1 / {s}^{2} ,$$
a dimension of a three-dimensional space coordinate is [x=(x, y, z)]=m, a dimension of a time coordinate is [t]=s, [xₛ]=m is a position of a source function, and a dimension of the source function is the source function [f]=N/m⁴.

3. The amplitude preserving method according to claim 2, wherein a decomposition comprises strategy 1 and strategy 2; wherein
the strategy 1 comprises decomposing a two-way sound wave equation (1) into a coupled one-way wave equation, which comprises:
assuming that
$$D = \frac{1}{2} ( \frac{\partial }{\partial z} + Λ ) p ( x , t ) and U = \frac{1}{2} ( \frac{\partial }{\partial z} - Λ ) p ( x , t ) ,$$
the equation (1) being decomposed into:
$$\{ \begin{matrix}( \frac{\partial }{\partial z} - Λ ) D - \frac{{Λ}_{z}}{2 Λ} ( D - U ) = - \frac{1}{2} f \\ ( \frac{\partial }{\partial z} + Λ ) U - \frac{{Λ}_{z}}{2 Λ} ( U - D ) = - \frac{1}{2} f\end{matrix} \qquad ( 2 )$$
wherein D and U are down-going and up-going wave fields, respectively, and a dimension of the both is N/m³;
a symbol of a pseudo-differential operator
$$Λ = \sqrt{\frac{1}{{υ}^{2} ( x )} \frac{{\partial }^{2}}{\partial {t}^{2}} - \frac{{\partial }^{2}}{\partial {x}^{2}} - \frac{{\partial }^{2}}{\partial {y}^{2}}}$$
has a dimension of 1/m, and a frequency wave number domain thereof is expressed as
$$Λ = {ik}_{z} = i \sqrt{\frac{{ω}^{2}}{{υ}^{2}} - {k}_{x}^{2} - {k}_{y}^{2}} ;$$
a symbol of a pseudo-differential operator
$${Λ}_{z} = \frac{\partial Λ}{\partial z}$$
has a dimension of 1/m².

4. The amplitude preserving method according to claim 3, wherein the strategy 2 comprises decomposing the two-way sound wave equation (1) into the coupled one-way wave equation, which comprises:
assuming that D*=D/\sqrt{Λ} and U*=U/\sqrt{Λ}, the equation (1) being decomposed into:
$$\{ \begin{matrix}( \frac{\partial }{\partial z} - Λ ) {D}^{*} - \frac{{Λ}_{z}}{2 Λ} {U}^{*} = - \frac{1}{2 \sqrt{Λ}} f \\ ( \frac{\partial }{\partial z} + Λ ) {U}^{*} + \frac{{Λ}_{z}}{2 Λ} {D}^{*} = - \frac{1}{2 \sqrt{Λ}} f\end{matrix} \qquad ( 3 )$$
wherein D* and U* are decomposed wave fields of down-going and up-going waves different from the dimensions of D and U, respectively, and a dimension of the both is
$$N / {m}^{\frac{5}{2}} .$$

5. The amplitude preserving method according to claim 4, wherein the establishing an amplitude preserving form and boundary value condition comprises establishing a true amplitude equation and boundary condition of a down-going wave through equations (2) and (3), which is expressed as follows:
the true amplitude equation and boundary condition of the down-going wave established by equation (2) is:
$$\{ \begin{matrix}( \frac{\partial }{\partial z} - Λ - \frac{{Λ}_{z}}{2 Λ} ) D ( x , t ) = 0 \\ D ( x , t ; z = {z}_{s} ) = - \frac{1}{2 Λ} f ( x , t ; z = {z}_{s} )\end{matrix} \qquad ( 4 )$$
the true amplitude equation and boundary condition of the down-going wave established by equation (3) is:
$$\{ \begin{matrix}( \frac{\partial }{\partial z} - Λ ) {D}^{*} ( x , t ) = 0 \\ {D}^{*} ( x , t ; z = {z}_{s} ) = - \frac{{Λ}^{- \frac{3}{2}}}{2} f ( x , t ; z = {z}_{s} )\end{matrix} . \qquad ( 5 )$$

6. The amplitude preserving method according to claim 5, wherein the traditional one-way wave processing flow comprises selecting a Generalized Screen Propagator (GSP) as a one-way wave amplitude preserving-implemented method, and determining an approximate solution of a one-way wave operator L as follows:
according to equation (5), the approximate solution Λ₀^{W} of the GSP of the one-way wave operator L in the frequency wave number domain is:
$${Λ}_{0}^{W} ( {x}_{T} , z ) = \sqrt{\frac{{ω}^{2}}{{υ}_{o}^{2}} + \frac{{\partial }^{2}}{\partial {x}_{T}^{2}}} + \frac{ω}{{υ}_{0}} ( \frac{1}{m} - 1 ) + \frac{ω}{{υ}_{0}} \frac{{a}_{1} ( m - 1 ) \frac{{υ}_{o}^{2}}{{ω}^{2}} \frac{{\partial }^{2}}{\partial {x}_{T}^{2}}}{1 + {b}_{1} ( 1 + {m}^{2} ) \frac{{υ}_{o}^{2}}{{ω}^{2}} \frac{{\partial }^{2}}{\partial {x}_{T}^{2}}} \qquad ( 6 )$$
wherein x_{T}=(x, y) denotes a plane coordinate, ω is an angular momentum, and v₀ is a reference velocity at a depth z;
$$m = m ( x ) = \frac{υ ( x )}{{υ}_{0} ( z )}$$
is a lateral velocity change; when
$$\frac{1}{{k}^{2} ( {x}_{T} , z )} \frac{{\partial }^{2}}{\partial {x}_{T}^{2}} = 0 ,$$
assuming that first to third derivatives of Λ and Λ₀^{W} are equal to each other, optimal optimization parameters are solved as a₁=0.5 and b₁=0.25; three terms in equation (6) comprise a phase shift term, a phase correction term and a wide-angle finite difference correction term, and operators corresponding to the three terms are referred to as a one-way wave generalized screen propagator, a phase correction operator and a wide-angle amplitude correction operator.

7. The amplitude preserving method according to claim 6, wherein the recursive equation comprises a recursive equation of a down-going wave field p of a one-way wave with a sound pressure dimension obtained according to down-going wave fields with different dimensions; wherein
according to the down-going wave field D with the dimension of N/m³ in equation (4), the recursive equation of the down-going wave field p of the one-way wave with the sound pressure dimension obtained after the dimension is normalized is as follows:
$$\{ \begin{matrix}p ( x , z , t ) = \frac{D ( x , z , t )}{Λ} , z = {z}_{s} \\ \frac{p ( x , z + Δ z , t )}{p ( x , z , t )} = \frac{Λ ( x , z , t ) D ( x , z + Δ z , t )}{Λ ( x , z + Δ z , t ) D ( x , z , t )} z > {z}_{s}\end{matrix} \qquad ( 7 )$$
wherein Δz is a depth step, and zₛ is a depth of a source function;
according to the down-going wave field D* with the dimension of
$$\\ N / {m}^{{}_{} \frac{5}{2}}$$
in equation (5), the recursive equation of the down-going wave field p of the one-way wave with the sound pressure dimension obtained after the dimension is normalized is as follows:
$$\\ \begin{matrix}\{ \begin{matrix}p ( x , z , t ) = \frac{{D}^{{}_{} *} ( x , z , t )}{\sqrt{Λ}} , z = {z}_{s} \\ \frac{p ( x , z + Δ z , t )}{p ( x , z , t )} = \frac{\sqrt{Λ ( x , z , t )} {D}^{{}_{} *} ( x , z + Δ z , t )}{\sqrt{Λ ( x , z + Δ z , t )} {D}^{{}_{} *} ( x , z , t )} , z > {z}_{s}\end{matrix} & ( 8 )\end{matrix}$$
wherein Δz is a depth step, and zₛ is a depth of the source function.

8. An amplitude preserving system based on symmetry of generalized Hamilton operators, which is based on the amplitude preserving method according to claim 1, wherein steps of the amplitude preserving method are implemented by any computer programming language, and a program is compiled and operated on any operating system and any hardware structure.

9. The amplitude preserving system according to claim 8, wherein the dimensions comprise dimensions of physical quantities in a constant-density sound pressure equation, and the constant-density sound pressure equation is expressed as:
$$\\ \begin{matrix}[ \frac{1}{{v}^{{}_{} 2} ( x )} \frac{{\partial }^{{}_{} 2}}{\partial {t}^{{}_{} 2}} - {∇}^{{}_{} 2} ] p ( x , t ) = - f ( x , t ; {x}_{s} ) & ( 1 )\end{matrix}$$
wherein the dimensions of the respective physical quantities in equation (1) are as follows: a sound pressure is [p]=N/m², a sound wave propagation velocity is [v]=m/s, a Laplace operator is [∇²]=1/m², a time second-order partial derivative is
$$\\ [ \frac{{\partial }^{{}_{} 2}}{\partial {t}^{{}_{} 2}} ] = 1 / {s}^{{}_{} 2} ,$$
a dimension of a three-dimensional space coordinate is [x=(x, y, z)]=m, a dimension of a time coordinate is [t]=s, [xₛ]=m is a position of a source function, and a dimension of the source function is the source function [f]=N/m⁴.

10. The amplitude preserving system according to claim 9, wherein a decomposition comprises strategy 1 and strategy 2; wherein
the strategy 1 comprises decomposing a two-way sound wave equation (1) into a coupled one-way wave equation, which comprises:
assuming that
$$\\ D = \frac{1}{2} ( \frac{\partial }{\partial z} + Λ ) p ( x , t ) and U = \frac{1}{2} ( \frac{\partial }{\partial z} - Λ ) p ( x , t ) ,$$
the equation (1) being decomposed into:
$$\\ \begin{matrix}\{ \begin{matrix}( \frac{\partial }{\partial z} - Λ ) D - \frac{{Λ}_{z}}{2 Λ} ( D - U ) = - \frac{1}{2} f \\ ( \frac{\partial }{\partial z} + Λ ) U - \frac{{Λ}_{z}}{2 Λ} ( U - D ) = - \frac{1}{2} f\end{matrix} & ( 2 )\end{matrix}$$
wherein D and U are down-going and up-going wave fields, respectively, and a dimension of the both is N/m³;
a symbol of a pseudo-differential operator
$$\\ Λ = \sqrt{\frac{1}{{v}^{{}_{} 2} ( x )} \frac{{\partial }^{{}_{} 2}}{\partial {t}^{{}_{} 2}} - \frac{{\partial }^{{}_{} 2}}{\partial {x}^{{}_{} 2}} - \frac{{\partial }^{{}_{} 2}}{\partial {y}^{{}_{} 2}}}$$
has a dimension of 1/m, and a frequency wave number domain thereof is expressed as
$$\\ Λ = {ik}_{z} = i \sqrt{\frac{{ω}^{{}_{} 2}}{{v}^{{}_{} 2}} - {k}_{x}^{{}_{} 2} - {k}_{y}^{{}_{} 2}} ;$$
a symbol of a pseudo-differential operator
$$\\ {Λ}_{z} = \frac{\partial Λ}{\partial z}$$
has a dimension of 1/m².

11. The amplitude preserving system according to claim 10, wherein the strategy 2 comprises decomposing the two-way sound wave equation (1) into the coupled one-way wave equation, which comprises:
assuming that D*=D/\sqrt{Λ} and U*=U/\sqrt{Λ}, the equation (1) being decomposed into:
$$\\ \begin{matrix}\{ \begin{matrix}( \frac{\partial }{\partial z} - Λ ) {D}^{{}_{} *} - \frac{{Λ}_{z}}{2 Λ} {U}^{{}_{} *} = - \frac{1}{2 \sqrt{Λ}} f \\ ( \frac{\partial }{\partial z} + Λ ) {U}^{{}_{} *} + \frac{{Λ}_{z}}{2 Λ} {D}^{{}_{} *} = - \frac{1}{2 \sqrt{Λ}} f\end{matrix} & ( 3 )\end{matrix}$$
wherein D* and U* are decomposed wave fields of down-going and up-going waves different from the dimensions of D and U, respectively, and a dimension of the both is
$$\\ N / {m}^{{}_{} \frac{5}{2}} .$$

12. The amplitude preserving system according to claim 11, wherein the establishing an amplitude preserving form and boundary value condition comprises establishing a true amplitude equation and boundary condition of a down-going wave through equations (2) and (3), which is expressed as follows:
the true amplitude equation and boundary condition of the down-going wave established by equation (2) is:
$$\\ \begin{matrix}\{ \begin{matrix}( \frac{\partial }{\partial z} - Λ - \frac{{Λ}_{z}}{2 Λ} ) D ( x , t ) = 0 \\ D ( x , t ; z = {z}_{s} ) = - \frac{1}{2 Λ} f ( x , t ; z = {z}_{s} )\end{matrix} & ( 4 )\end{matrix}$$
the true amplitude equation and boundary condition of the down-going wave established by equation (3) is:
$$\\ \begin{matrix}\{ \begin{matrix}( \frac{\partial }{\partial z} - Λ ) {D}^{{}_{} *} ( x , t ) = 0 \\ {D}^{{}_{} *} ( x , t ; z = {z}_{s} ) = - \frac{{Λ}^{- \frac{3}{2}}}{2} f ( x , t ; z = {z}_{s} )\end{matrix} . & ( 5 )\end{matrix}$$

13. The amplitude preserving system according to claim 12, wherein the traditional one-way wave processing flow comprises selecting a Generalized Screen Propagator (GSP) as a one-way wave amplitude preserving-implemented method, and determining an approximate solution of a one-way wave operator L as follows:
according to equation (5), the approximate solution Λ₀^{W} of the GSP of the one-way wave operator L in the frequency wave number domain is:
$$\\ \begin{matrix}{Λ}_{0}^{{}_{} W} ( {x}_{T} , z ) = \sqrt{\frac{{ω}^{{}_{} 2}}{{v}_{0}^{{}_{} 2}} + \frac{{\partial }^{{}_{} 2}}{\partial {x}_{T}^{{}_{} 2}}} + \frac{ω}{{v}_{0}} ( \frac{1}{m} - 1 ) + \frac{ω}{{v}_{0}} \frac{{a}_{1} ( m - 1 ) \frac{{v}_{o}^{{}_{} 2}}{{ω}^{{}_{} 2}} \frac{{\partial }^{{}_{} 2}}{\partial {x}_{T}^{{}_{} 2}}}{1 + {b}_{1} ( 1 + {m}^{{}_{} 2} ) \frac{{v}_{o}^{{}_{} 2}}{{ω}^{{}_{} 2}} \frac{{\partial }^{{}_{} 2}}{\partial {x}_{T}^{{}_{} 2}}} & ( 6 )\end{matrix}$$
wherein x_{T}=(x, y) denotes a plane coordinate, ω is an angular momentum, and v₀ is a reference velocity at a depth z;
$$\\ m = m ( x ) = \frac{v ( x )}{{v}_{0} ( z )}$$
is a lateral velocity change; when
$$\\ \frac{1}{{k}^{{}_{} 2} ( {x}_{T} , z )} \frac{{\partial }^{{}_{} 2}}{\partial {x}_{T}^{{}_{} 2}} = 0 ,$$
assuming that first to third derivatives of Λ and Λ₀^{W} are equal to each other, optimal optimization parameters are solved as a₁=0.5 and b₁=0.25; three terms in equation (6) comprise a phase shift term, a phase correction term and a wide-angle finite difference correction term, and operators corresponding to the three terms are referred to as a one-way wave generalized screen propagator, a phase correction operator and a wide-angle amplitude correction operator.

14. The amplitude preserving system according to claim 13, wherein the recursive equation comprises a recursive equation of a down-going wave field p of a one-way wave with a sound pressure dimension obtained according to down-going wave fields with different dimensions; wherein
according to the down-going wave field D with the dimension of N/m³ in equation (4), the recursive equation of the down-going wave field p of the one-way wave with the sound pressure dimension obtained after the dimension is normalized is as follows:
$$\\ \begin{matrix}\{ \begin{matrix}p ( x , z , t ) = \frac{D ( x , z , t )}{Λ} , z = {z}_{s} \\ \frac{p ( x , z + Δ z , t )}{p ( x , z , t )} = \frac{Λ ( x , z , t ) D ( x , z + Δ z , t )}{Λ ( x , z + Δ z , t ) D ( x , z , t )} z > {z}_{s}\end{matrix} & ( 7 )\end{matrix}$$
wherein Δz is a depth step, and zₛ is a depth of a source function;
according to the down-going wave field D* with the dimension of
$$\\ N / {m}^{{}_{} \frac{5}{2}}$$
in equation (5), the recursive equation of the down-going wave field p of the one-way wave with the sound pressure dimension obtained after the dimension is normalized is as follows:
$$\\ \begin{matrix}\{ \begin{matrix}p ( x , z , t ) = \frac{{D}^{{}_{} *} ( x , z , t )}{\sqrt{Λ}} , z = {z}_{s} \\ \frac{p ( x , z + Δ z , t )}{p ( x , z , t )} = \frac{\sqrt{Λ ( x , z , t )} {D}^{{}_{} *} ( x , z + Δ z , t )}{\sqrt{Λ ( x , z + Δ z , t )} {D}^{{}_{} *} ( x , z , t )} , z > {z}_{s}\end{matrix} & ( 8 )\end{matrix}$$
wherein Δz is a depth step, and zₛ is a depth of the source function.

15. A computer device, comprising:
a memory in which a computer program is stored; and
a processor, which, when executing the computer program, implements steps of the amplitude preserving method according to claim 1.

16. The computer device according to claim 15, wherein the dimensions comprise dimensions of physical quantities in a constant-density sound pressure equation, and the constant-density sound pressure equation is expressed as:
$$\\ \begin{matrix}[ \frac{1}{{v}^{{}_{} 2} ( x )} \frac{{\partial }^{{}_{} 2}}{\partial {t}^{{}_{} 2}} - {∇}^{{}_{} 2} ] p ( x , t ) = - f ( x , t ; {x}_{s} ) & ( 1 )\end{matrix}$$
wherein the dimensions of the respective physical quantities in equation (1) are as follows: a sound pressure is [p]=N/m², a sound wave propagation velocity is [v]=m/s, a Laplace operator is [∇²]=1/m², a time second-order partial derivative is
$$\\ [ \frac{{\partial }^{{}_{} 2}}{\partial {t}^{{}_{} 2}} ] = 1 / {s}^{{}_{} 2} ,$$
a dimension of a three-dimensional space coordinate is [x=(x, y, z)]=m, a dimension of a time coordinate is [t]=s, [xₛ]=m is a position of a source function, and a dimension of the source function is the source function [f]=N/m⁴.

17. The computer device according to claim 16, wherein a decomposition comprises strategy 1 and strategy 2; wherein
the strategy 1 comprises decomposing a two-way sound wave equation (1) into a coupled one-way wave equation, which comprises:
assuming that
$$\\ D = \frac{1}{2} ( \frac{\partial }{\partial z} + Λ ) p ( x , t ) and U = \frac{1}{2} ( \frac{\partial }{\partial z} - Λ ) p ( x , t ) ,$$
the equation (1) being decomposed into:
$$\\ \begin{matrix}\{ \begin{matrix}( \frac{\partial }{\partial z} - Λ ) D - \frac{{Λ}_{z}}{2 Λ} ( D - U ) = - \frac{1}{2} f \\ ( \frac{\partial }{\partial z} + Λ ) U - \frac{{Λ}_{z}}{2 Λ} ( U - D ) = - \frac{1}{2} f\end{matrix} & ( 2 )\end{matrix}$$
wherein D and U are down-going and up-going wave fields, respectively, and a dimension of the both is N/m³;
a symbol of a pseudo-differential operator
$$\\ Λ = \sqrt{\frac{1}{{v}^{{}_{} 2} ( x )} \frac{{\partial }^{{}_{} 2}}{\partial {t}^{{}_{} 2}} - \frac{{\partial }^{{}_{} 2}}{\partial {x}^{{}_{} 2}} - \frac{{\partial }^{{}_{} 2}}{\partial {y}^{{}_{} 2}}}$$
has a dimension of 1/m, and a frequency wave number domain thereof is expressed as
$$\\ Λ = {ik}_{z} = i \sqrt{\frac{{ω}^{{}_{} 2}}{{v}^{{}_{} 2}} - {k}_{x}^{{}_{} 2} - {k}_{y}^{{}_{} 2} ;}$$
a symbol of a pseudo-differential operator
$$\\ {Λ}_{z} = \frac{\partial Λ}{\partial z}$$
has a dimension of 1/m².

18. The computer device according to claim 17, wherein the strategy 2 comprises decomposing the two-way sound wave equation (1) into the coupled one-way wave equation, which comprises:
assuming that D*=D/\sqrt{Λ} and U*=U/\sqrt{Λ}, the equation (1) being decomposed into:
$$\\ \begin{matrix}\{ \begin{matrix}( \frac{\partial }{\partial z} - Λ ) {D}^{{}_{} *} - \frac{{Λ}_{z}}{2 Λ} {U}^{{}_{} *} = - \frac{1}{2 \sqrt{Λ}} f \\ ( \frac{\partial }{\partial z} + Λ ) {U}^{{}_{} *} + \frac{{Λ}_{z}}{2 Λ} {D}^{{}_{} *} = - \frac{1}{2 \sqrt{Λ}} f\end{matrix} & ( 3 )\end{matrix}$$
wherein D* and U* are decomposed wave fields of down-going and up-going waves different from the dimensions of D and U, respectively, and a dimension of the both is
$$\\ N / {m}^{{}_{} \frac{5}{2}} .$$

19. The computer device according to claim 18, wherein the establishing an amplitude preserving form and boundary value condition comprises establishing a true amplitude equation and boundary condition of a down-going wave through equations (2) and (3), which is expressed as follows:
the true amplitude equation and boundary condition of the down-going wave established by equation (2) is:
$$\\ \begin{matrix}\{ \begin{matrix}( \frac{\partial }{\partial z} - Λ - \frac{{Λ}_{z}}{2 Λ} ) D ( x , t ) = 0 \\ D ( x , t ; z = {z}_{s} ) = - \frac{1}{2 Λ} f ( x , t ; z = {z}_{s} )\end{matrix} & ( 4 )\end{matrix}$$
the true amplitude equation and boundary condition of the down-going wave established by equation (3) is:
$$\\ \begin{matrix}\{ \begin{matrix}( \frac{\partial }{\partial z} - Λ ) {D}^{{}_{} *} ( x , t ) = 0 \\ {D}^{{}_{} *} ( x , t ; z = {z}_{s} ) = - \frac{{Λ}^{- \frac{3}{2}}}{2} f ( x , t ; z = {z}_{s} )\end{matrix} . & ( 5 )\end{matrix}$$

20. A non-transitory computer-readable storage medium on which a computer program is stored, wherein the computer program, when executed by a processor, implements steps of the amplitude preserving method according to claim 1.
